(19) United States
(12) Patent Application Publication
(10) Pub. No.: US 2022/0178274 A1
(43) Pub. Date: Jun. 9, 2022

(54) TURBOCHARGER

(71) Applicant: Ford Global Technologies, LLC, Dearborn, MI (US)

(72) Inventors: Sam Watton, Kent (GB); Andrew Hitchings, Cardiff (GB)

(21) Appl. No.: 17/110,695

(22) Filed: Dec. 3, 2020

(51) Int. Cl. F01D 25/04; F01D 25/24; F04D 29/66; F02B 39/00

(52) U.S. Cl. CPC F01D 25/04; F01D 25/24; F04D 29/665; F05D 2260/96; F05D 2220/40; F05D 2240/14; F02B 39/00

(57) ABSTRACT

There is provided a turbocharger comprising a compressor housing having an inner surface defining a flow path between an inlet and an outlet of a compressor of the turbocharger. The compressor housing is configured to support a compressor wheel supported therewithin. The inner surface of the compressor housing comprises an indent formed into the inner surface. At least a portion of the indent is located upstream of the compressor wheel in an assembled configuration. The indent comprises a portion that is undercut into the housing towards the inlet.

### BACKGROUND

The present disclosure relates to a turbocharger, and in particular, but not exclusively, to a turbocharger compressor housing configured to improve the Noise Vibration and Harshness (NVH) characteristics of the turbocharger.

### SUMMARY

It is common for an engine to be fitted with a turbocharger to increase the performance and/or efficiency of the engine. In recent years, there has been a tendency to downsize and reduce the operational speed of an engine, e.g., to meet customer demand and/or legislative requirements. Furthermore, advances in aftertreatment requirements means that turbocharger NVH characteristics are pushed to the limit by means of their operating conditions and environment. Yet still, the introduction of secondary gas inlet streams at or near the turbocharger compressor can increase turbocharger whoosh/hiss, which may push flow type NVH characteristics into unacceptable ranges.

A turbocharger, a compressor housing and a vehicle are provided herein for reducing NVH characteristics associated with turbocharger operation.

According to some aspects, there is provided a turbocharger comprising a housing, e.g., a compressor housing, having an inner surface defining a flow path between an inlet and an outlet of a compressor of the turbocharger. The compressor housing is configured to support a compressor wheel within the housing. In an assembled configuration, the turbocharger comprises at least the compressor housing and the compressor wheel supported therein. The inner surface of the compressor housing comprises an indent, such as a cavity, a groove, a channel, a recess and/or a pocket. The indent may be formed into the inner surface, thereby defining a region at least partially separated from the main flow path through the compressor. At least a portion of the indent is located upstream of the compressor wheel in an assembled configuration. For example, a portion of the indent may be upstream of a leading edge of a vane of the compressor wheel, and another portion of the indent may be downstream of a leading edge of the vane of the compressor wheel. The indent comprises a portion that is undercut into the housing towards the inlet. For example, the indent may comprise a recessed portion having a lip that separates radially a portion of flow, e.g., reversal flow, from the main flow path through the compressor. In some examples, the indent is located proximate to the inlet to the compressor wheel, such that any reverse flow generated, e.g., when the compressor is operating close to the surge limit, is able to flow into a space defined by the indent in the inner surface, rather than (directly) mixing with the main flow through the compressor.

In some examples, the indent comprises a groove extending at least partially around the inner surface of the compressor housing. The groove may have any appropriate profile. For example, the groove may have a lobe-shaped profile, when viewed in a longitudinal plane of the compressor housing. In some examples, the groove comprises a partially toroidal surface that defines the undercut portion of the indent.

In some examples, the cross-sectional profile of the groove may vary circumferentially, e.g., in a manner similar to the profile of the volute of the compressor.

In some examples, the indent may be discontinuous in a circumferential direction. For example, the indent feature may comprise a plurality of discrete pockets spaced circumferentially around and/or longitudinally along the inner surface of the compressor housing.

In some examples, the indent comprises a downstream edge, e.g., that leads into the indent. The downstream edge may be located at a first transverse plane of the inlet. The first transverse plane may be spaced axially upstream of a leading edge of a vane of the compressor wheel by a distance L1, wherein L1 is in the range of 0 mm to 35 mm. In some examples, the first transverse plane of the inlet may be spaced axially downstream of a leading edge of a vane of the compressor wheel by a distance L1′, wherein L1′ is in the range of 0 mm to 5 mm.

In some examples, the indent comprises a bottom surface defining the extent by which the indent is undercut towards the inlet. The bottom surface may be spaced axially upstream of the first transverse plane by a distance L2, wherein L2 is in the range of 3 mm to 30 mm.

In some examples, the indent comprises an upstream edge located at a second transverse plane of the inlet. The second transverse plane may be spaced axially upstream of the first transverse plane by a distance L3, wherein L3 is less than distance L2.

In some examples, the bottom surface may be at least partially circular, in a longitudinal cross section of the compressor housing. The at least partially circular profile may have a center of radius located at a third transverse plane of the inlet. The third transverse plane may be spaced axially upstream of the first transverse plane of the compressor by a distance L4, wherein L4 is in the range of 2 mm to 20 mm. In some examples, the at least partially circular profile intersects the inner surface of the inlet. The radius of the at least partially circular profile may be in the range of 1 mm to 10 mm.

In some examples, the downstream edge defines a first radial dimension of the inlet. In some examples, the upstream edge defines a second radial dimension of the inlet. The first radial dimension may be different from the second radial dimension. In some examples, the transverse cross section of the inlet varies, e.g., in size and/or shape, along the length of the inlet.

In some examples, the housing comprises at least one secondary gas inlet. The indent may be located downstream of the secondary gas inlet. For example, the undercut portion of the indent may be proximate and downstream of the transition of the secondary gas inlet into the compressor housing.

According to some aspects, there is provided a compressor housing configured to support a compressor wheel within the housing, the housing having an inner surface defining a flow path between an inlet and an outlet of the housing, the inner surface comprising an indent located upstream of the compressor wheel in an assembled configuration, wherein the indent is undercut towards an inlet end of the housing.

According to some aspects, there is provided a vehicle having a turbocharger. The turbocharger has a compressor housing configured to support a compressor wheel therein, the compressor housing having an inner surface defining a flow path between an inlet and an outlet of the housing, the inner surface comprising an indent located upstream of the compressor wheel, wherein the indent is undercut towards an inlet end of the housing.

According to some aspects, there is provided a method of forming a compressor housing, the compressor housing being configured to support a compressor wheel therewithin, the compressor housing having an inner surface defining a flow path between an inlet and an outlet of the housing, the method comprising forming an indent in the inner surface, the indent being undercut towards the inlet of the housing an being located upstream of the compressor wheel, in an assembled configuration.

In some examples, the indent may be formed as a single feature in the compressor housing, e.g., by virtue of a machining operation. In some examples, the compressor housing may be assembled from multiple parts, e.g., a compressor body and a compressor inlet. In some examples, a first portion of the indent may be formed in a first part of the compressor housing, e.g., the compressor body, and a second portion of the indent may be formed in a second part of the compressor housing, e.g., the compressor inlet. The indent may be formed, e.g., in its entirety, by virtue of the assembly of the first and second parts of the compressor housing.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 illustrates a turbocharger system, in accordance with some examples of the disclosure;

FIG. 2 is a cross section through a flow path of a turbocharger compressor housing, in accordance with some examples of the disclosure;

FIG. 3 is a parameterized representation of a cross section through a turbocharger compressor housing, in accordance with some examples of the disclosure;

FIG. 4 is a graphical representation of operational NVH characteristics, in accordance with some examples of the disclosure; and

FIG. 5 is a diagrammatic representation of a vehicle, in accordance with some examples of the disclosure.

### DETAILED DESCRIPTION

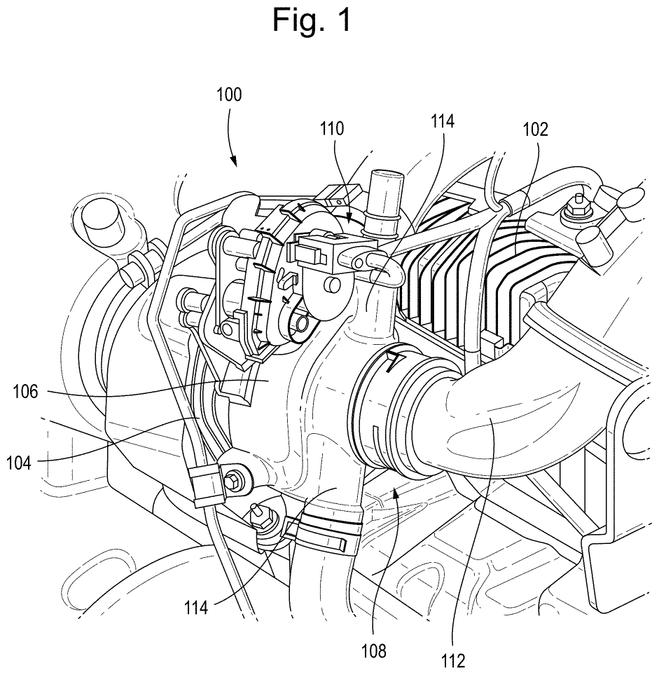

FIG. 1 illustrates a turbocharger system 100 coupled to an engine 102. The turbocharger system 100 comprises a turbocharger 104 and a plurality of ducts for flowing gas to/from the turbocharger 104. In the example shown in FIG. 1, the turbocharger 104 comprises a compressor housing 106 configured to support a compressor wheel. The compressor housing 106 defines a flow path between an inlet 108 of the compressor housing 106 and an outlet 110 of the compressor housing 106. An inlet duct 112, e.g., of an air intake system, is coupled to the inlet 108 of the turbocharger 104, and an outlet duct 112 is coupled to the outlet 110 of the turbocharger 104. The turbocharger system 100 shown in FIG. 1 additionally comprises two secondary inlets 114 configured to direct gas from another gas flow component of the engine, e.g., the secondary inlet may be a low pressure exhaust gas recirculation spigot, a crank case vent spigot, and/or and an evaporative emissions spigot. In the example shown in FIG. 1, the secondary inlets 114 are integral to the compressor housing 106. However, in one or more other examples, the secondary inlets may be part of the inlet duct 112, or may not even be part of the system 100.

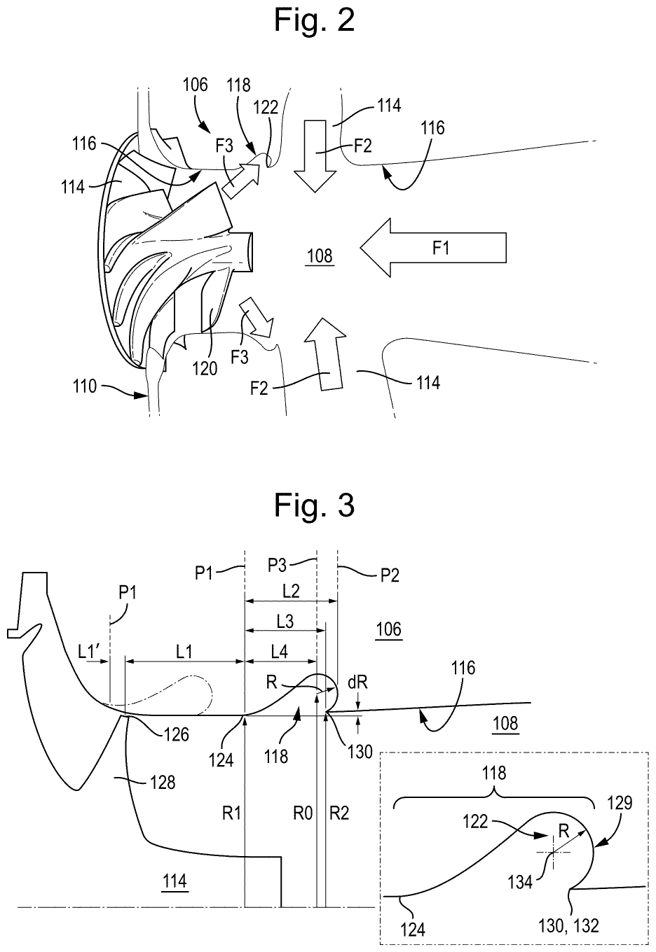

FIG. 2 shows a cross section of the flow path through the compressor housing 106. The compressor wheel 114 is not shown in cross section for visual clarity. The compressor housing 106 comprises an inner surface 116 that defines the flow path from the inlet 108 to the outlet 110. Arrow F1 indicates the direction of the main flow through the compressor housing 106. Arrows F2 indicate the direction of the secondary flow from the secondary inlets 114.

The inner surface 116 of the compressor housing 106 comprises an indent 118, e.g., a recessed space or cavity, located upstream of the compressor wheel 114. In the context of the present disclosure, the term “upstream” is a relative term indicating a location in the flow path further towards the inlet 108 of the compressor housing. Similarly, the term “downstream” is a relative term indicating a location in the flow path further away from the inlet 108 of the compressor housing. Thus, in the example shown in FIG. 2, the indent 118 is shown at a location in the compressor housing 106 further towards the inlet 108 than the compressor wheel 114, e.g., at a location further towards the inlet 108 than a vane 120 of the compressor wheel 114.

Indent 118 comprises a portion that is undercut into, e.g., radially behind, the inner surface 116 of the compressor housing 106 towards the inlet 118 (herein after referred to at the undercut 122). In the example shown in FIG. 2, the undercut 122 is defined by a cavity radially outside of the flow path through the compressor housing 106. Importantly, the undercut 122 comprises a lip that extends axially downstream from a bottom surface of the undercut 122, thus separating radially, at a given transverse plane of the compressor housing 106, the undercut cavity from the flow path.

In the example shown in FIG. 2, the indent 118 comprises a lobe-shaped groove that extends circumferentially around the inner surface 116 of the compressor housing 106. The groove is positioned axially upstream of a vane inlet tip of the compressor wheel 114, and downstream of the secondary inlets 112. However, the indent 118 may be positioned at any appropriate position upstream from at least a portion of the compressor wheel 114, irrespective of whether the compressor housing 106 has any secondary inlets 112. Whilst the indent 118 is shown as a lobe-shaped groove in FIG. 2, the indent may be any appropriate shape, e.g., profile, having a portion that is undercut into the inner surface 116 of the compressor housing 106 in the manner described above. For example, the indent may comprise a square-shaped cavity radially separated from the main flow path. In some examples, the indent 118 may comprise one or more pockets each extending around a portion of the circumference of the inner surface 116 of the compressor housing 106. For example, the indent 118 may be formed into the compressor housing 106 in one or more regions local to where the secondary flow F2 meets the main flow F1.

The benefit of the undercut feature is that flow through the compressor housing 106 is managed such that interaction between reverse flow F3, e.g., at the inlet to the compressor wheel 114, and the main flow F1 and/or the secondary flow F2 is reduced or avoided. In this manner, the interaction between flow regimes that typically promote the generation of turbocharger whoosh/hiss noise is reduced. As such, the undercut 122 helps to mitigate NVH error states, e.g., by directing and/or separating any reverse flow F3 away from the main flow F1 and/or the secondary flow F2. Furthermore, reverse flow F3 within the indent 118 is directed back towards the main flow F1 and/or the secondary flow F2 as a result of the geometry, specifically the undercut 122, of the indent 118.

FIG. 3 is a representation of a cross section through the compressor housing 106, which shows various parameters of the geometry of the indent 118. In the example shown in FIG. 3, the indent 118 comprises a downstream edge 124 located at a first transverse plane P1 of the inlet 108. In some examples, downstream edge 124 of the indent 118 defines a lead-in, e.g., ramped surface, that transitions the inner surface 116 to the undercut 122. The first transverse plane P1 is spaced axially upstream of a leading edge 126 of a vane 128 of the compressor wheel 114 by a distance L1. In some examples, distance L1 is in the range of approximately 0 mm to 35 mm. In other examples, the first transverse plane P1 may be spaced axially downstream of the leading edge 126 of the vane 128 of the compressor wheel 114 by a distance L1′, wherein L1′ is in the range of approximately 0 mm to 5 mm. Such an alternative is shown by the dashed indent geometry of FIG. 3. In such an example, whilst edge 124 is downstream of the leading edge 126 of the vane 126, the remaining portion of the indent 118, and specifically the undercut 122, is upstream of edge 126 of the compressor wheel 114.

In the example shown in FIG. 3, the undercut 122 comprises a bottom surface 129 defining the extent by which the indent 118 is undercut towards the inlet 108. In the example shown in FIG. 3, the bottom surface 129 is spaced axially upstream of the first transverse plane P1 by a distance L2. In some examples, L2 is in the range of approximately 3 mm to 30 mm. Thus, distance L2 defines the total axial dimension of the indent 118, e.g., the distance between the downstream edge 124 and the bottom surface 129 of the indent 118.

The indent 118 further comprises an upstream edge 130 located at a second transverse plane P2 of the inlet 106. Upstream edge 130 defines the transition between the bottom surface 129 of the undercut 128 and the inner surface 116 of the compressor housing 106. For example, upstream edge 130 may define a lip 132 that radially separates, at transverse plane P2, undercut cavity 122 from the main flow path F1. In the example shown in FIG. 3, the second transverse plane P2 is spaced axially upstream of the first transverse plane P1 by a distance L3. It is understood that for the undercut feature to exist, distance L3 should be less than distance L2.

In the example shown in FIG. 3, bottom surface 129 is approximately semi-circular in form. As such, it will be appreciated that undercut 122 comprises a (partially) toroidal cavity that is separated from the main flow F1. Such a shape may be beneficial over other shapes, since any reversed flow that is captured may be encouraged to re-join the main flow F1 in a manner that avoids or reduces further disturbances in the overall flow regime that may lead to NVH error states.

In the example shown in FIG. 3, the at least partially circular surface (bottom surface 129) has a center of radius 134 located at a third transverse plane P3 of the inlet 108. The third transverse plane P3 is spaced axially upstream of the first transverse plane P1 by a distance L4. In some examples, L4 is in the range of approximately 2 mm to 20 mm. The radius R of the at least partially circular surface is in the range of approximately 1 mm to 10 mm. It can be seen, therefore, that the extent by which the indent 118 is undercut towards the inlet 108, e.g., distance L2, is a function of, at least, distance L4 and radius R. Additionally, the position of the center of radius 134 may be defined by a radial dimension R0, measured from the longitudinal axis of the compressor housing 106.

In the example shown in FIG. 3, the downstream edge 124 defines a first radial dimension R1 of the inlet 108 and the upstream edge 130 defines a second radial dimension R2 of the inlet 108. In some examples, the radius of the inlet 108 varies along its length. As such, the first radial dimension R1 may be different from the second radial dimension R2, e.g., by a distance dR. In FIG. 3, the second radial dimension R2 is larger than the first radial dimension R1. However, in another example, the second radial dimension R2 may be smaller than the first radial dimension R1. Distance dR may be chosen based on one or more operational characteristics of the compressor, e.g., operational speeds at which whoosh/hiss are more prevalent. For example, dR may be in the range of −3 to +5 mm (-ve being a protrusion into the main duct diameter).

In the example shown in FIG. 3, the indent 118 may be formed using any appropriate tooling and manufacturing method, e.g., undercut 122 may be formed by a cutting operation that removes material from the inner surface 116 of the inlet 106. Additionally or alternatively, undercut 122 may be formed as a cast feature during the manufacture of compressor housing 106. In some examples, the indent 118 may be formed as a single feature in the compressor housing 106. In other examples, the indent 118 may be formed by virtue of a multiple part assembly. For example, a portion of the indent 118 may be formed into a first portion of the compressor housing 106 and another portion of the indent 118 formed into another part, e.g., a second portion of the compressor housing 106 or inlet duct 112. In some examples, the compressor housing 106 may comprise an inlet portion attachable to a main portion of the compressor housing 106, the inlet portion having the indent 118 formed as a single feature therein.

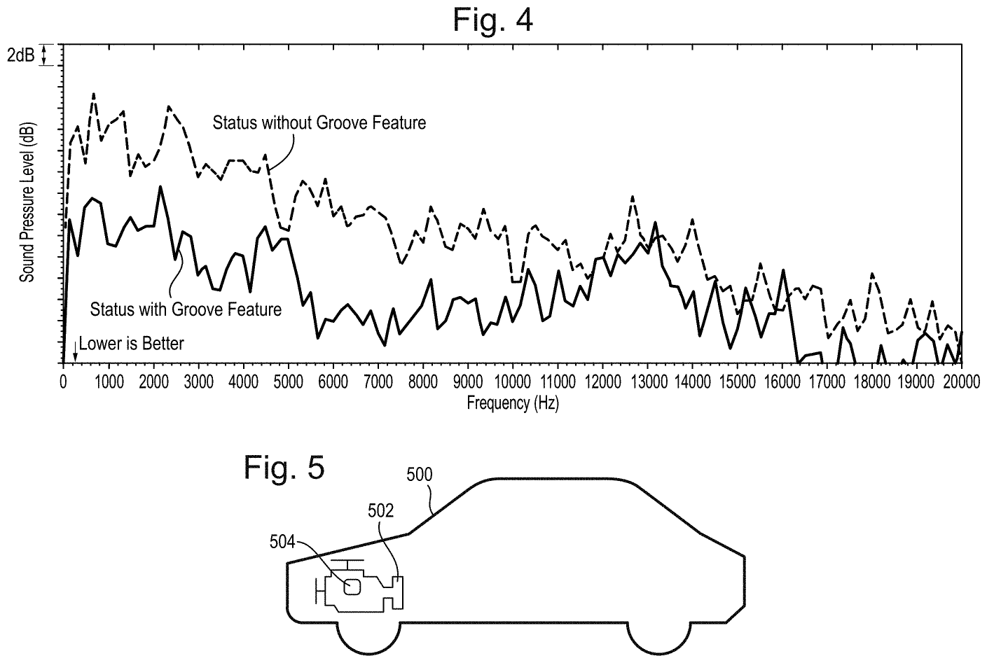

FIG. 4 is an exemplary graphical representation of operational NVH characteristics of a conventional compressor housing (dashed line) and the compressor housing 106 according to the present disclosure (solid line). Specifically, FIG. 4 shows the sound pressure level (SPL) plotted against frequency for each of the housings when operating the compressor at 1500 RPM close to the surge limit, which is an operational point at which NVH error states may be promoted. Importantly, FIG. 4 demonstrates a reduction in the SPL across nearly all of the frequency range (0-20000 Hz).

FIG. 5 is a diagrammatic representation of a vehicle 500, in accordance with some examples of the disclosure. The vehicle 500 comprises an engine 502 and a turbocharger 504 having features similar to those described above with reference to FIGS. 1 to 3.

The processes and systems described above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one example may be applied to any other example herein, and flowcharts or examples relating to one example may be combined with any other example in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A turbocharger comprising:
a housing having an inner surface defining a flow path between an inlet and an outlet of a compressor of the turbocharger; and
a compressor wheel supported within the housing, the inner surface comprising an indent having a portion that is located upstream of the compressor wheel and undercut into the housing towards the inlet.

2. The turbocharger according to claim 1, wherein the indent comprises a circumferential groove.

3. The turbocharger according to claim 1, wherein the indent is discontinuous in a circumferential direction.

4. The turbocharger according to claim 1, the indent comprising a downstream edge (leading into the indent and) located at a first transverse plane of the inlet, the first transverse plane being spaced axially upstream of a leading edge of a vane of the compressor wheel by a distance L1, wherein L1 is in the range of 0 mm to 35 mm.

5. The turbocharger according to claim 1, the indent comprising a downstream edge (leading into the indent and) located at a first transverse plane of the inlet, the first transverse plane being spaced axially downstream of a leading edge of a vane of the compressor wheel by a distance L1′, wherein L1′ is in the range of 0 mm to 5 mm.

6. The turbocharger according to claim 4 or 5, the indent comprising a bottom surface defining the extent by which the indent is undercut towards the inlet, the bottom surface being spaced axially upstream of the first transverse plane by a distance L2, wherein L2 is in the range of 3 mm to 30 mm.

7. The turbocharger according to claim 6, the indent comprising an upstream edge located at a second transverse plane of the inlet, the second transverse plane being spaced axially upstream of the first transverse plane by a distance L3, wherein L3 is less than distance L2.

8. The turbocharger according to claim 6, wherein the profile of the bottom surface, in a longitudinal cross section of the compressor housing, is at least partially circular.

9. The turbocharger according to claim 8, wherein the at least partially circular profile has a center of radius located at a third transverse plane of the inlet, the third transverse plane being spaced axially upstream of the first transverse plane of the compressor by a distance L4, wherein L4 is in the range of 2 mm to 20 mm.

10. The turbocharger according to claim 8, wherein the at least partially circular profile intersects the inner surface of the inlet.

11. The turbocharger according to claim 9, wherein the radius of the at least partially circular profile is in the range of 1 mm to 10 mm.

12. The turbocharger according to claim 1, wherein the indent comprises a downstream edge located at a first transverse plane of the inlet, and an upstream edge located at a second transverse plane of the inlet, the downstream edge defining a first radial dimension of the inlet and the upstream edge defining a second radial dimension of the inlet, where in the first radial dimension is different from the second radial dimension.

13. The turbocharger according to claim 1, wherein the indent is lobe-shaped in a longitudinal cross section of the inlet.

14. The turbocharger according to claim 1, wherein the transverse cross section of the inlet varies along the length of the inlet.

15. The turbocharger according to claim 1, the housing comprising a secondary gas inlet, wherein the indent is downstream of the secondary gas inlet.

16. A compressor housing having an inner surface defining a flow path between an inlet and an outlet of the compressor housing and being configured to support a compressor wheel therein, the inner surface comprising an indent having a portion that is located upstream of the compressor wheel in an assembled configuration and undercut into the housing towards the inlet.

17. A vehicle having a turbocharger, the turbocharger comprising:
a housing having an inner surface defining a flow path between an inlet and an outlet of a compressor of the turbocharger; and
a compressor wheel supported within the housing, the inner surface comprising an indent having a portion that is located upstream of the compressor wheel and undercut into the housing towards the inlet.
